(19) United States
(12) Patent Application Publication
(10) Pub. No.: US 2007/0271345 A1
(43) Pub. Date: Nov. 22, 2007

(54) METHOD AND SYSTEM FOR PROVIDING EMAIL CONTINUITY

(76) Inventors: Sean Callanan, Churchtown (IE); Al Chakra, Cary, NC (US); Joseph D. Galluzzo, Raleigh, NC (US); Patrick J. O'Sullivan, Ballsbridge (IE)

Correspondence Address: HOFFMAN, WARNICK & D'ALESSANDRO LLC, 75 STATE ST, 14TH FLOOR, ALBANY, NY, 12207, US

(21) Appl. No.: 11/555,380

(22) Filed: Nov. 1, 2006

(30) Foreign Application Priority Data
May 16, 2006 (GB) 0609650.7

(51) Int. Cl. G06F 15/16

(52) U.S. Cl. 709/206

(57) ABSTRACT

A method and system are provided for providing email continuity by automatically following up an email message to which a reply has not been received. A method in accordance with an embodiment of the invention includes: defining a workflow as a plurality of actions to be taken in a predetermined order, wherein the actions are configured to generate a response to an email message; indicating that a workflow is to be applied in relation to an email message to a recipient; and monitoring email activity to identify a reply from the recipient to the email message and, in the absence of a reply, automatically applying the workflow.

### FIELD OF THE INVENTION

This invention relates to the field of email messaging systems. In particular, it relates to following up email messages which have not been responded to, providing email continuity.

### BACKGROUND OF THE INVENTION

In large organizations that are distributed worldwide and are separated by time zones, it is easy to see how communication problems arise. As the office-time overlap in working days can be short or non-existent, personal contact is difficult making email messaging the central means by which professionals collaborate.

The need to assign tasks and motivate responses by using email messaging is an implied part of most businesses and industries.

It is often frustrating to workflow and deadlines when email messages that have been sent are not responded to and the contents not addressed. Typically, in many roles in the work place, some portion of the day is spent following up email messages to which a response has not been received, and trying to motivate responses to questions that need to be answered or actions that need to be addressed.

The time lost in actively tracking threads associated with email messages that are not responded to and motivating a turnaround to such email messages could be productively spent on other tasks.

In known email systems, a user can create areas or folders for email messages that the user needs an answer to or needs to follow up on. However, this requires manual intervention by the user to transfer emails to this folder, to remind the user to review the folder regularly, and to remove email messages from this folder once actions are addressed. Threads associated with these activities need independent management and tracking.

In some known email systems, such as Lotus Notes (Lotus Notes is a trade mark of International Business Machines Corporation), the user has the option to stamp messages with a “Please reply by date,” which results in the placement of reminder messages in the originator's and recipient's “To Do” lists. However, this requires manual operation of the user to review and send the reminder message.

A user can also introduce semantics to his email system and email messages can be highlighted, color coded, grouped, and/or prioritized using specified capabilities. This can help in organization and prioritization but, again, this is a manual effort by the user.

The area of activity and thread management in known email systems, enables a user of an email thread to identify the associated responses (or lack of responses) to a thread or email message, regardless of the number of iterations. However, once again, motivating continuity in such an email thread is manual and requires the user to track such threads and the associated activities that require response.

The conventional art forces users to establish their own tracking processes. For some, this may mean selective categorization of the user's email activity and managing the categories carefully. For others, this may imply the creation of to do lists that are reminder-based or calendar events to remind the user not to forget a specific action or thread that they need action on.

### SUMMARY OF THE INVENTION

According to a first aspect of the present invention there is provided a method for providing email continuity, comprising: defining a workflow as a plurality of actions to be taken in a predetermined order, wherein the actions are configured to generate a response to an email message; indicating that a workflow is to be applied in relation to an email message to a recipient; monitoring email activity to identify a reply from the recipient to the email message and, in the absence of a reply, automatically applying the workflow.

The plurality of actions defined in a workflow can escalate in the forcefulness of their approach. The plurality of actions can include one or more of the group of: re-sending an email message, changing the mood or priority of an email message and re-sending the email message, copying the email message to the recipient's superior, copying the email message to the recipient's higher superior, copying the message to the sender's superior, etc.

In one embodiment, the actions of the workflow can be each applied after a predetermined time period. In an alternative embodiment, the next action in a workflow can be applied after a predetermined number of iterations of a previous action.

The workflow can be associated with a recipient or a group of recipients on a thread of email messages. The workflow can be predefined for a recipient or a group of recipients.

The workflow can be tracked showing the status of the actions and the actions taken. The workflow can also be adjustable in use to change one or more actions or a recipient.

When an action is taken, a report can be sent to the sender of the email message to inform the sender of the action.

In the event an insufficient reply is received in response to the email message, the workflow can be re-applied from any step in the predetermined order of actions.

According to a second aspect of the present invention there is provided a system for providing email continuity, comprising: a client application comprising means for sending an email message flagged for monitoring continuity; and a server application comprising: means for monitoring a reply to the flagged email message, and means for applying a workflow comprising a plurality of actions to be taken in a predetermined order, wherein the workflow is stopped when a reply to the flagged email message is received

The client application can include a user interface for inputting a workflow comprising a plurality of actions in a predetermined order for a recipient of an email message.

The means for applying a workflow can be in the form of a server sub-system including an actions engine and a rules engine.

The client application can include a tracking user interface for tracking the plurality of actions. The tracking user interface can include means for interrupting or changing the plurality of actions. The tracking user interface can also include means for sending the email message to another recipient.

The system can include a report generator, wherein, when an action in a workflow is applied, a report is sent to the sender of the email message from the report generator to inform the sender of the action.

In the event an insufficient reply is received in response to the email message, the tracking user interface can include means for re-applying the workflow from any step in the predetermined order of actions.

According to a third aspect of the present invention there is provided a computer program product stored on a computer readable storage medium, comprising computer readable program code for performing the steps of: defining a workflow as a plurality of actions to be taken in a predetermined order, wherein the actions are configured to generate a response to an email message; indicating that a workflow is to be applied in relation to an email message to a recipient; and monitoring email activity to identify a reply from the recipient to the email message and, in the absence of a reply, automatically applying the workflow.

Using the proposed method and system, the originator of an email message can configure a mechanism to motivate a response to the email message at the time of creation of the email message. This means that the originator does not have to initiate any follow on threads or actions. An automated mechanism for motivating the recipient to furnish a response is provided, and in situations where a response is required and not forthcoming, to automatically and passively motivate a set of actions on behalf of the originator to attempt to prompt the response.

### BRIEF DESCRIPTION OF THE DRAWINGS

Embodiments of the present invention will now be described, by way of examples only, with reference to the accompanying drawings.

FIG. 1 is a block diagram of an illustrative email system in accordance with an embodiment of the present invention.

FIG. 2 is a flow diagram of an illustrative method in accordance with an embodiment of the present invention.

FIG. 3 is a flow diagram of an illustrative method in accordance with an embodiment of the present invention.

FIGS. 4A to 4D are illustrative representations of graphical user interfaces in accordance with an embodiment of the present invention.

### DETAILED DESCRIPTION OF THE INVENTION

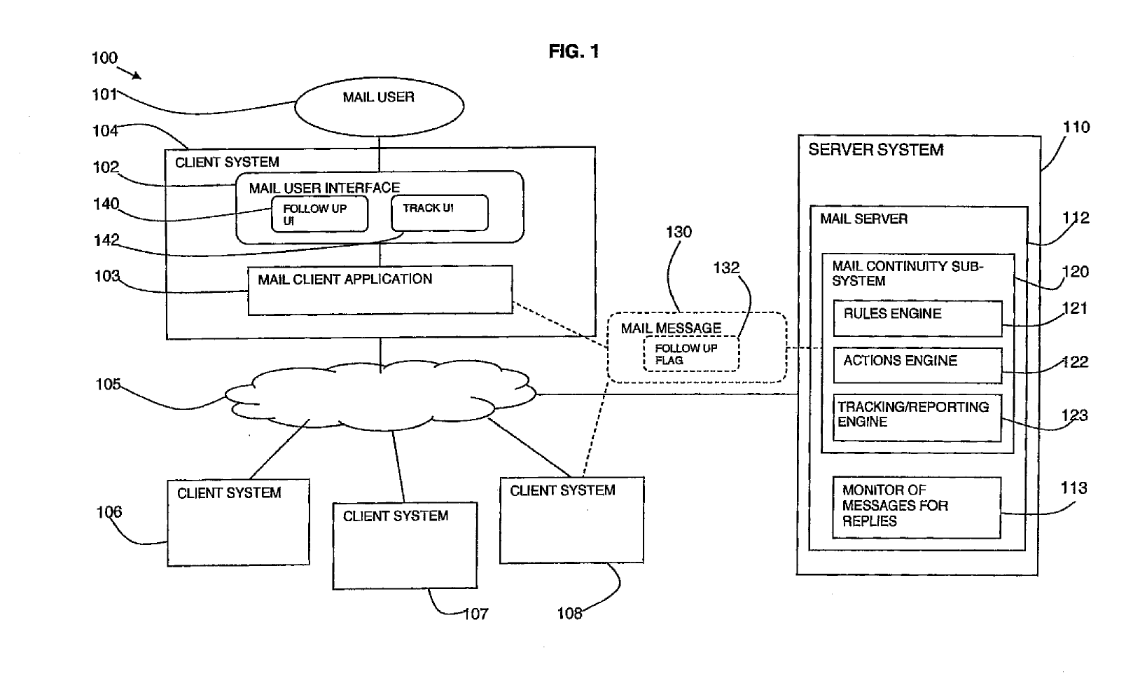

Referring to FIG. 1, an email system 100 is shown including an email user 101 who interacts with an email user interface 102 of an email client application 103 running on a client computer system 104. The email client application 103 can be a stand alone email application or part of a combined scheduling and calendar application.

The email client application 103 communicates via a network 105 with other client computer systems 106-108 each running their own email client application. A server system 110 provides the email server application 112.

In the described system, the server system 110 also provides a mail continuity sub-system 120 as a groupware including a rules engine 121, an actions engine 122, and a tracking and reporting engine 123.

An email message 130 sent by an email user 101 has the option to be flagged 132 as requiring continuity, which is managed by the mail continuity sub-system 120. The server system 110 also includes a monitor 113 for monitoring email message traffic for replies to messages 130 that have been flagged 132.

The mail continuity sub-system 120 keeps track of the email messages 130 an email user 101 has flagged 132 for continuity tracking. A user's interest profile for email messages 130 is maintained. Information in this profile is recorded server side 110 for all users who use the mail continuity sub-system 120 and client side 104 in the event that the user 101 prefers to work in an offline mode. In this way, the information flow is bi-directional.

At the point when the email user 101 has created an email message 130 and has identified the recipients of the message 130, the described system provides an option to apply email continuity actions to the message 130.

The email user 101 creating an email message 130 is furnished with a user interface (UI) 102 with a function 140 to define a set of continuity actions that will be instigated if a response is not received to the email message 130 within a pre-defined time period. The UI function 140 provides the ability for each recipient listed on the email message 130 to have independent associated actions. For example, for Recipient 1, the sender may decide that sending the email message once again will suffice, for Recipient 2 the sender may decide that copying the email message to their manager is required, and it may be that a response is not required from Recipient 3.

The following options are provided in the UI function 140 furnished to the email user 101 creating and sending the email message 130.

The email user 101 can motivate a response to an email message 130 by a pre-determined time. If a response to the email message 130 is not forthcoming within this pre-determined time, a set of user defined actions will be automatically carried out by the mail continuity sub-system 120.

The actions are instigated by an actions engine 122 and can be chosen from one or more of the following examples; however, other forms of action can also be included.
The email message 130 is automatically re-sent.
The email message 130 is automatically re-sent with a higher priority/mood stamp set.
The email message 130 is automatically re-sent and copied to the recipient's manager.
The email message 130 is automatically re-sent and copied to the recipient's manager and manager's manager.
The email message 130 is automatically re-sent and copied to the sender's manager.
The email message 130 is automatically re-sent and a “to do” action is motivated, where the priority of the “to do” action can be assigned by the email user 101.
The email message 130 is automatically re-sent with any other actions deemed desirable by the email user 101 and appropriate to a particular recipient.
The email message 130 is automatically re-sent with any combination of the above.

The actions are included in the actions engine 122. In each case, after an action is taken, if there is still no response within a further pre-defined time period (which can be the same or different to the first pre-defined time period) the process can iterate to the next action according to the rules specified in the rules engine 121 that the email user 101 has set.

In the described system, the rules engine 121 provides a rule base against which the workflow can be stipulated that the email user 101 desires for email messages 130 requiring a response from a recipient. For example, the rule base can include but is not limited to, the following.

The email user 101 can choose what time interval is best before the automated system re-sends the email message 130. This could be any defined time period, for example, one hour, one day, one week, one year, etc.

The email user 101 can choose an escalation rule that becomes activated once a response is not received—either within a defined time period, or having failed to motivate a response following a number of automated attempts. An example of an escalation rule might include “copy recipients manager”, “copy recipient's manager's manager”, and so on. Another example, might be to increase the priority stamp at each re-send of the email message.

The email user 101 can decide that for the purpose of a specific thread, attempts are first made to satisfy Rule 1 and, in the absence of a response, Rule 2 then applies. For example, Rule 1 may re-send the email message N times, where N is defined by the email user 101, and Rule 2 may send a high priority, an adjusted mood stamp, assign a “to do” action, copy the sender's manager, or copy the recipients manager, etc.

The rule bases included in the rules engine 121 can include but are not limited to:
The ability to associate an independent automated action against any one (or more) individuals on an email thread.
The ability to associate a number of independent automated actions against any one (or more) individuals on an email thread in the order deemed desirable by the sender.
The ability to cancel any workflow once a response is returned and the rules sub-system has deemed that a response has been received. At this point the email user can decide that the response is not the desired one and have the system and method continue as per the rules defined, or modify the rules associated with the thread accordingly.
Any other rules that are deemed desirable by the email user.

The combination of the actions engine 122 and the rules engine 121 enable an email user 101 sending an email message 130 to configure automatic actions that respect the email user's intentions for each recipient of an email message 130. The rule bases of the rules engine 121 can be individually tailored to specific recipients on a given thread, so that a sequence of events for one recipient can differ from that of another recipient. The rules engine 121 respects an orderly workflow as defined by the email user 101.

For example, a workflow can be an escalation of actions in incremental steps as follows:
Step 1 N reminders over a time period defined by the sender.
Step 2 Change in mood stamp.
Step 3 User of organizational distance in an LDAP (Lightweight Directory Access Protocol) such that the recipient's manager is automatically copied the message.
Step 4 Recipient's manager and the manager's manager are copied.

The degree of configurability can be adjusted in a given thread of email messages so that recipients in the thread are assigned a user-specific workflow. Some of the recipients can default to a conventional workflow, whereas others can be subject to reminders, change in priority, mood stamp changes, manager informing, etc.

Over time and usage, an email user 101 can define rules and workflows for certain recipients to meet the user's requirements. For example, if an email user 101 previously found it difficult to get a response from Recipient X, then a workflow can be reused from a previous interaction to achieve a timely result. The workflows associated with the recipients can be persistent so the workflow can be surfaced in a user interface and reused.

A re-sent email message sent to a recipient as an action in a rule can be identified as nth escalation of the rule. This can be done by appending to the subject field or adding a notation to the body of the email message indicating the current iteration of the message.

The tracking and reporting engine 123 can furnish the email user 101 sending the email message 130 with the ability to do various tasks. The email user interface 102 has an additional UI function 142 for tracking options. Examples of tasks which can be carried out by the email user 101 using the UI function 142 can include the following:
Assess status against any thread that the email user 101 has marked as requiring automated prompts/continuity.
Assess the full history of automated actions taken on behalf of the email user 101.
Assess the subsequent automated actions that are about to take place regarding any one or all automated actions about to take place on the user's system.
Permit the email user 101 to adjust/change rules associated with any thread—which could imply cancelling automated actions in part/full, or modifying order/priority/steps of actions.
Incorporate any other tracking and reporting information that are deemed desirable by the email user 101.

In addition, the tracking and reporting engine 123 can be configured to send an email message back to the email user 101 to report on the action taken. For example, to indicate that “Recipient A has not replied to your email, I have taken the following action . . . ”. This is useful for users who may not remember to follow up the using the status feature.

The tracking and reporting engine 123 provides the email user 101 sending the message 130 with an ability to assess, track and adjust aspects of the workflow that have been specified or are in progress. In situations where the user has prompted a number of automatic actions for a plurality of threads/events, this is a useful capability. It also gives the email user 101 a point in time context for actions that have been passively actioned on the user's behalf, as well as the current status in relation to the workflow assigned. Corrective actions or revisions of the workflow at this point are at the user's discretion. If the email user is not getting a satisfactory result, then the email user is at liberty to change/adapt the workflow, or even assign a replacement recipient for the recipient who is not responding.

In some situations, a response to an email message 130 may not be the desired response. In such situations, the email user can re-apply the defined workflow at any step to get the desired response.

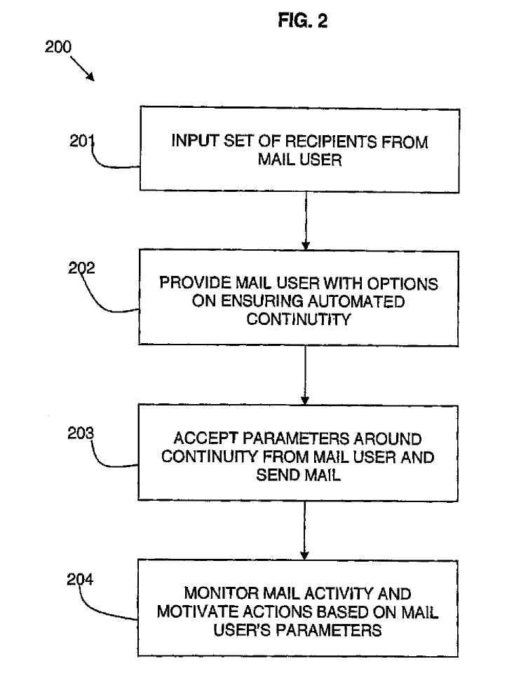

FIG. 2 shows a flow diagram 200 of a method of implementing a workflow associated with an individual email recipient where a set of decisions/parameters can govern actions that result in automated actions on behalf of the sending email user.

The sending email user inputs the set of recipients 201. The sending email user is provided 202 with options for ensuring automated continuity. The sending email user inputs the parameters and sends the email message 203. The email message activity is monitored 204 and the defined actions are motivated based on the sending email user's parameters.

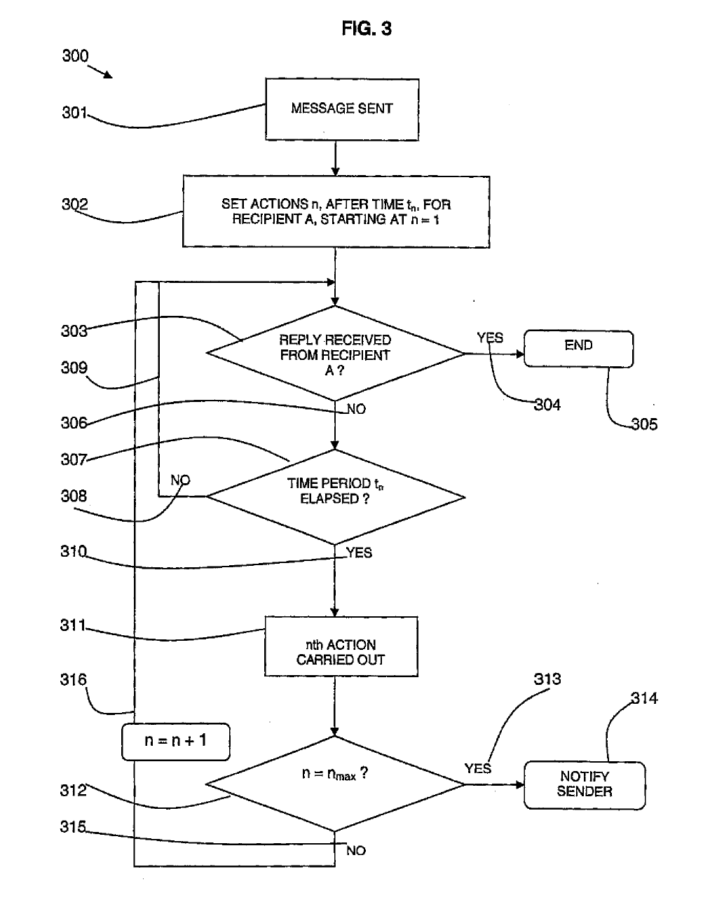

FIG. 3 shows a flow diagram 300 of details of the step 204 of FIG. 2. FIG. 3 is an example embodiment of an implementation of a workflow.

A email message is sent 301 and a sequence of actions n (n=1, 2, 3) are defined 302 to be carried out after time periods tₙ(tₙ=t₁, t₂, t₃) for a recipient A of the email message.

It is determined 303 if a reply has been received from recipient A. If a reply has been received 304, the workflow ends 305. If no reply has been received 306, it is determined 307 if time period tₙ has elapsed. If time tₙ has not elapsed 308, the workflow loops 309 to monitor a reply from the recipient 303. If time tₙ has elapsed 310, the n^{th} action is instigated 311.

It is then determined 312 if n=nₘₐₓ. If so 313, the sender of the email message is notified 314 that all the workflow actions have been taken and no response has been forthcoming from the recipient. If n<nₘₐₓ 315, the workflow loops 316 to monitor a reply from the recipient 303 and the action is incremented n=n+1.

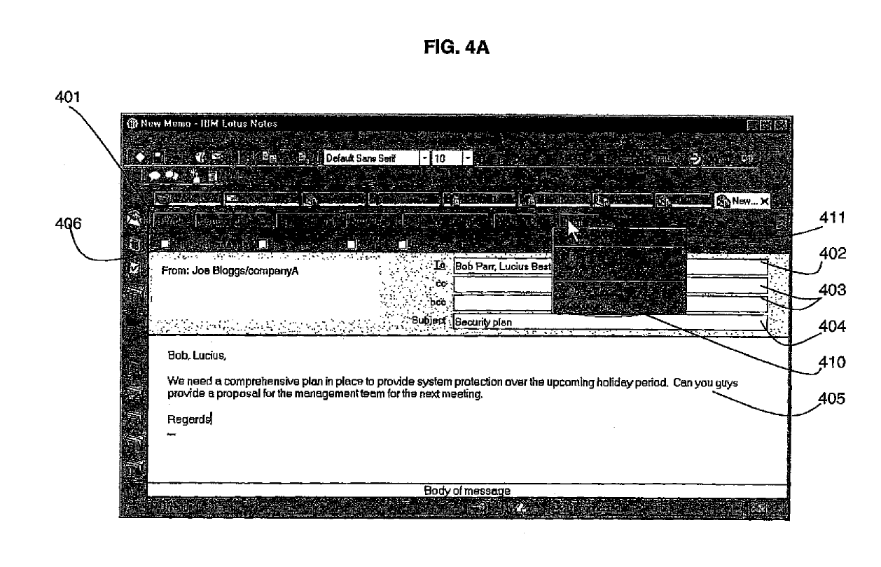

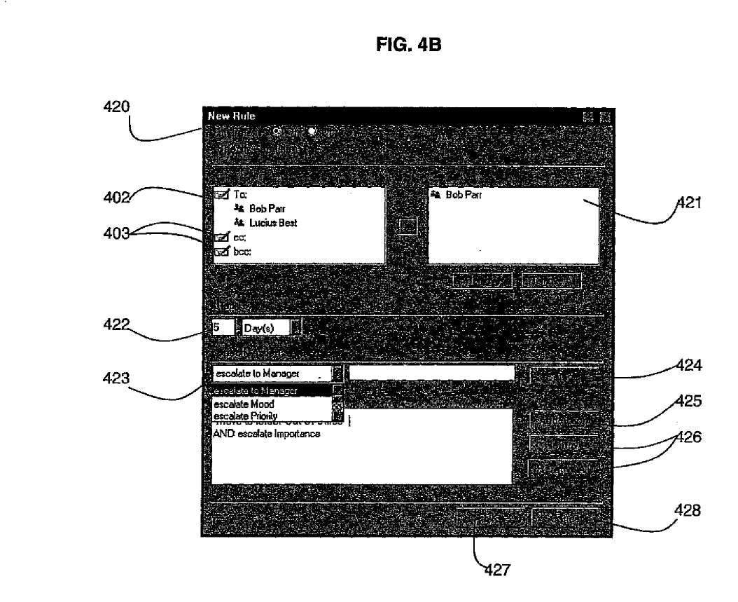

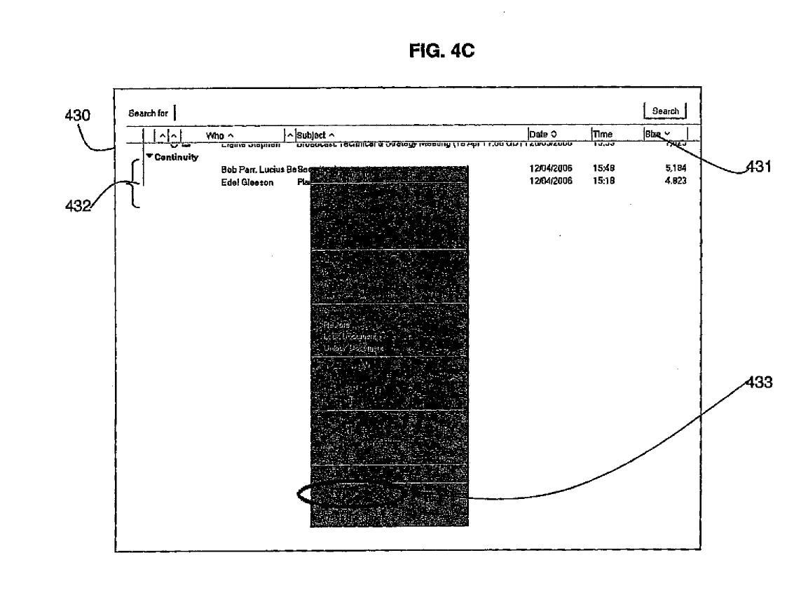

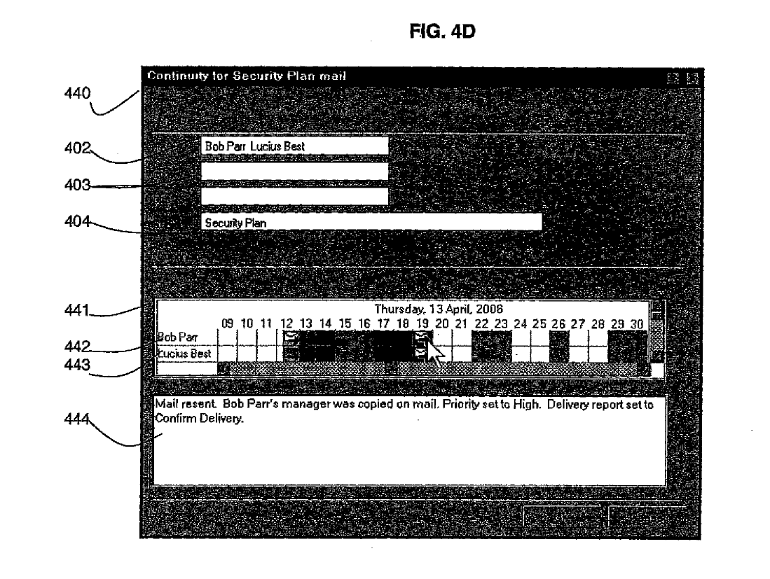

Referring to FIGS. 4A to 4D, graphical representations of example graphical user interfaces (GUIs) providing the described functions are shown.

FIG. 4A shows a graphical user interface (GUI) 401 presented to an email user when creating an email message. The usual functions of such a GUI are provided including input boxes for the email message recipients 402, copy recipients (cc and bcc) 403, and subject 404. A message text 405 can be inserted with attachments as required. Priority tags 406 can be added to the email message.

An option 410 for continuity settings is provided on the GUI 401. In FIG. 4A this is provided as an option in the tools pull down menu 411. If this option 410 is selected, a rule GUI 420 shown in FIG. 4B is presented to the email user.

FIG. 4B shows a rule GUI 420 in which the aspects of a continuity rule to be applied to one or more of the recipients 402 or copy recipients 403 is provided. Separate rule GUIs 420 can be opened for different recipients or sub-groups of recipients and copy recipients.

The rule GUI 420 includes a list of the recipients 402 and copy recipients 403 of the email message from which the recipients to be included in the rule can be selected 421. An input box is included for inputting the time period 422 for reply to the email message before an action is taken.

A pull down list 423 of actions is provided from which an action can be selected 424. Actions can be added 425 and removed 426 from the rule. When the email user is satisfied with the rule specified, the rule is accepted by selecting the “OK” button 427. The rule GUI can be aborted by selecting the “cancel” button 428.

When a rule is accepted, the rule GUI 420 will close and the rule applied to the email message.

FIG. 4C shows a GUI 430 of an email system showing an inbox 431 for mail messages. A list 432 of email messages to which continuity rules have been applied is provided. An email message can be selected and the an option of the continuity tracking 433 selected for further information relating to the continuity actions taken for the email message.

If the continuity tracking option 433 is selected, a tracking GUI 440 (FIG. 4D) is presented to the email user. The tracking GUI 440 includes details of the email message to which it relates including the recipients 402, copy recipients 403, and subject 404. The continuity details 441 can be presented in many different ways, and an embodiment showing a date-line with actions taken for each recipient 442, 443 to which a continuity rule is applied is shown in FIG. 4D.

The date-line for a recipient 442, 443 shows the actions taken and a corresponding commentary 444 can be included.

The above system and method would eliminate the manual efforts associated with management of email threads. In instances where there are multiple threads, the system and method make life easier for a sending email user based on automated workflow. The system would be of great use to well organized individuals who would benefit from automatic management of threads based on rules as well as reporting information based on these threads. It would also be on benefit to less organized people who may send emails expecting to get a response and forget about the issue/topic/thread once the email message has been sent. This system and method remembers these threads and can remind the user in ways that include structured actions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

What is claimed is:

1. A method for providing email continuity, comprising:
defining a workflow as a plurality of actions to be taken in a predetermined order, wherein the actions are configured to generate a response to an email message;
indicating that a workflow is to be applied in relation to an email message to a recipient; and
monitoring email activity to identify a reply from the recipient to the email message and, in the absence of a reply, automatically applying the workflow.

2. The method as claimed in claim 1, wherein the plurality of actions defined in the workflow escalate in a forcefulness of their approach.

3. The method as claimed in claim 1, wherein the plurality of actions includes at least one of: re-sending the email message, changing a mood or priority of the email message and re-sending the email message, copying the email message to a superior of the recipient, copying the email message to a higher superior of the recipient, and copying the email message to a superior of a sender of the email message.

4. The method as claimed in claim 1, wherein the actions of the workflow are each applied after a predetermined time period.

5. The method as claimed in claim 1, wherein a next action in the workflow is applied after a predetermined number of iterations of a previous action in the workflow.

6. The method as claimed in claim 1, wherein the workflow is associated with a recipient or a group of recipients on a thread of email messages.

7. The method as claimed in claim 1, wherein the workflow is predefined for a recipient or a group of recipients.

8. The method as claimed in claim 1, wherein the workflow is tracked showing a status of the actions and the actions taken.

9. The method as claimed in claim 1, wherein the workflow is adjustable in use to change one or more actions or a recipient of the email message.

10. The method as claimed in claim 1, wherein, when an action is taken, a report is sent to a sender of the email message to inform the sender of the action taken.

11. The method as claimed in claim 1, wherein, in the event an insufficient reply is received in response to the email message, the workflow is re-applied from any step in the predetermined order of actions.

12. A system for providing email continuity, comprising:
a client application comprising means for sending an email message flagged for monitoring continuity; and
a server application comprising:
means for monitoring a reply to the flagged email message, and
means for applying a workflow comprising a plurality of actions to be taken in a predetermined order,
wherein the workflow is stopped when a reply to the flagged email message is received.

13. The system as claimed in claim 12, wherein the client application comprises a user interface for inputting a workflow comprising a plurality of actions in a predetermined order for a recipient of an email message.

14. The system as claimed in claim 12, wherein the means for applying the workflow is in the form of a server sub-system comprising an actions engine and a rules engine.

15. The system as claimed in claim 12, wherein the client application comprises a tracking user interface for tracking the plurality of actions.

16. The system as claimed claim 15, wherein the tracking user interface comprises means for interrupting or changing the plurality of actions.

17. The system as claimed in claim 15, wherein the tracking user interface comprises means for sending the email message to another recipient.

18. The system as claimed in claim 12, further comprising a report generator, wherein, when an action in the workflow is applied, a report is sent to a sender of the email message from the report generator to inform the sender of the action applied.

19. The system as claimed in claim 15, wherein the tracking user interface comprises means for re-applying the workflow from any step in the predetermined order of actions, in the event an insufficient reply is received in response to the email message.

20. A computer program product stored on a computer readable storage medium, comprising computer readable program code for performing the steps of:
defining a workflow as a plurality of actions to be taken in a predetermined order, wherein the actions are configured to generate a response to an email message;
indicating that a workflow is to be applied in relation to an email message to a recipient; and
monitoring email activity to identify a reply from the recipient to the email message and, in the absence of a reply, automatically applying the workflow.
